(19) United States
(12) Patent Application Publication
(10) Pub. No.: US 2025/0047178 A1
(43) Pub. Date: Feb. 6, 2025

(54) SYSTEM AND METHOD FOR MANUFACTURING AN ELECTRIC MOTOR

(71) Applicant: MAHLE International GmbH, Stuttgart (DE)

(72) Inventor: Simon Streng, Leonberg (DE)

(21) Appl. No.: 18/717,417

(22) PCT Filed: Oct. 12, 2022
(86) PCT No.: PCT/EP2022/078364

§ 371 Date: Jun. 6, 2024

(30) Foreign Application Priority Data
Dec. 6, 2021 (DE) 102021213834.9

(51) Int. Cl. H02K 15/02; H02K 3/02; H02K 3/04; H02K 3/30; H02K 3/34; H02K 15/12

(52) U.S. Cl. CPC H02K 15/024; H02K 3/02; H02K 3/04; H02K 3/30; H02K 3/345; H02K 15/12

(57) ABSTRACT

The present invention relates to a method for manufacturing an electric motor having a stator with stator slots and electrical conductors arranged therein. In order to achieve simple production, the following is planned, that at least two electrical conductors are sheathed in an extrusion process with an electrical insulator, which holds the at least two electrical conductors at a distance from one another and has at least one positioning contour, that the at least two electrical conductors together with the electrical insulator are inserted into an associated stator slot and fixed therein via the at least one positioning contour.

### CROSS-REFERENCE TO RELATED APPLICATIONS

This application claims priority to International Patent Application No. PCT/EP2022/078364 filed on Oct. 12, 2022, and German Patent Application No. DE 102021213834.9A filed on Dec. 6, 2021, the contents of both of which are hereby incorporated by reference in their entirety.

### TECHNICAL FIELD

The present invention relates to a method for manufacturing an electric motor having a stator with stator slots and electrical leads arranged therein according to the general terms of the independent claims. The invention also relates to an electric motor manufactured according to this method.

### BACKGROUND

EP 3 484 021 A1 discloses a generic method for manufacturing an electric motor with a stator with stator slots and electrical conductors arranged therein, in which the stator with the stator laminated core and the at least one stator slot is first manufactured in an injection molding process. At the same time, a tooth-shaped design of a slot wall insulation is formed during injection molding and an electrical conductor is provided. This is inserted into the tooth-shaped groove, in particular pushed in, wherein a gap is formed between individual conductors by the tooth-shaped design, through which a cooling fluid can flow.

US 2020/0153306 A1 also discloses a stator for an electric motor with stator slots in which electrical conductors are arranged. These electrical conductors are each individually encased in an electrical insulator and spaced apart from each other and from an inner groove wall surface. The individual electrical conductors are inserted individually into the corresponding stator slot.

A disadvantage of the manufacturing methods or electric motors known from the state of the art is that the respective electrical conductors have to be inserted individually into the stator slots, which makes the manufacturing process complex and therefore expensive.

The present invention therefore deals with the problem of providing an improved or at least an alternative embodiment for a method of the type according to the present invention, which overcomes the disadvantages known from the prior art.

According to the invention, this problem is solved by the subject matter of independent claims. Advantageous embodiments are the subject of the dependent claims.

The present invention is based on the general idea of overmolding several electrical conductors to be accommodated together in a common stator slot in advance in a common process step with an electrical insulator, which not only enables the conductors to be handled together, but in particular also enables them to be mounted and fixed together in the stator slot of a stator. In the method according to the invention for producing an electric motor having a stator with stator slots and electrical conductors arranged therein, at least two electrical conductors are encased in an extrusion process with an electrical insulator which, in the hardened state, holds the at least two electrical conductors at a distance from one another and has at least one positioning contour. The at least two electrical conductors together with the insulator surrounding them are then inserted into an associated stator slot and fixed in place using the at least one positioning contour of the electrical insulator. The wrapping of the at least two electrical conductors, for example significantly more electrical conductors, with the electrical insulator can take place in an upstream process step, whereupon the package of several electrical conductors held together by the electrical insulator applied in the extrusion process can simply be pushed into the associated stator slot. The method according to the invention thus considerably facilitates and simplifies the assembly of an electric motor and at the same time ensures a spatially precisely predefined position of the individual electrical conductors in the respective stator slot thanks to the electrical insulator. This makes it possible to create precisely predefined fluid channels between the electrical insulator and an inner wall of the respective stator slot, through which, for example, a coolant can flow during operation of the electric motor and cool the electric motor. In addition, the method according to the invention also eliminates the need for the previously required trickling method with resin, by means of which the electrical conductors were held or fixed in the respective stator groove. A further major advantage of the extrusion method used according to the invention for encasing the at least two electrical conductors with the electrical insulator made of plastic is that the electrical insulator can have almost any cross-sectional shape, so that individual cross-sectional shapes, including with positioning webs or positioning lugs, can be easily produced using appropriately shaped nozzles. Using these positioning bars or positioning lugs, the electrical conductors can be positioned not only at a precisely predefined distance from each other, but also in relation to an inner wall of the stator slot in the same, while at the same time limiting the corresponding fluid channels for guiding coolant.

The at least two electrical conductors are conveniently coated with a polyamideimide (PAI) or a polyether ether ketone (PEEK) as an electrical insulator in an extrusion process. Polyetheretherketone is a high-temperature-resistant thermoplastic that is not only easy to process by injection molding or extrusion method, but also provides reliable electrical insulation. Polyamidimides are also temperature-resistant and are even suitable for higher temperatures as long-term electrical insulators.

In a further advantageous embodiment of the method according to the invention, the at least two electrical conductors each have a rectangular cross-sectional shape, while the extruded electrical insulator encases each electrical conductor and has a positioning lug as a positioning contour on each side of each conductor. Such positioning lugs or positioning contours can be produced comparatively easily by designing the die accordingly in the extrusion method and serve not only to position the subsequent electrical conductors in the stator slot or relative to it, but also relative to each other. Two adjacent electrical conductors can, for example, be connected to each other via two positioning lugs arranged between them or connected to each other using the extrusion method. These two positioning lugs in contact with each other form a positioning bar that simultaneously fixes two conductors together. Spaced positioning lugs, which are supported on an inner wall of the respective stator slot when installed, can also be used to define fluid channels for a temperature control fluid, such as a coolant. The positioning contours therefore not only fulfill the function of precisely positioning the individual conductors in the stator slot, but also serve as flow guide elements for the coolant.

In a further advantageous embodiment of the method according to the invention, the at least two electrical conductors are coated with the electrical insulator only in a central region of the extrusion method, while these remain free at the respective longitudinal ends. This makes it easy to weld the respective electrical conductors, for example hairpins, at their respective axial longitudinal ends without having to remove the electrical insulator in advance.

For example, a copper conductor is used as the electrical conductor, which in turn can be solid or made up of individual strands.

The present invention is further based on the general idea of providing an electric motor manufactured according to the method described in the preceding paragraphs, which is easier to assemble and thus less expensive to manufacture due to the method according to the invention. By pre-fixing the individual electrical conductors relative to each other through the joint extrusion process, in which the electrical conductors are encased in an electrical insulator, it is also possible to achieve an exact arrangement of the conductors within the stator slot.

Further important features and advantages of the invention are apparent from the sub-claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

In each case schematically,

FIG. 1 an arrangement of several electrical conductors which are coated with an electrical insulator in an extrusion process according to the invention,

FIG. 2 several electrical conductors coated with an electrical insulator using the method according to the invention in a joint extrusion process,

FIG. 3 a sectional view of an electric motor manufactured according to the method of the invention in the region of a stator slot with electrical conductors arranged therein.

### DETAILED DESCRIPTION

According to FIGS. 2 and 3, in a method according to the invention for manufacturing an electric motor 1 with a stator 2 with stator slots 3, of which only one is shown according to FIG. 3, and with electrical conductors 4 arranged therein, a separate sheathing of the electrical conductors 4 with an electrical insulator 5 is first carried out in an extrusion process. In an extrusion process, at least two electrical conductors 4, preferably all electrical conductors 4 belonging in a respective associated stator slot 3, are sheathed with the electrical insulator 5, which holds the at least two electrical conductors 4 at a distance from one another and at the same time has at least one positioning contour 6, by means of which fixing or positioning of the individual conductors 4 in the subsequent stator slot 3 is made possible. The result of the extrusion process, in which the individual electrical conductors 4 are coated with the electrical insulator 5, is shown in FIG. 2. The electrical conductors 4 together with the electrical insulator 5 are then inserted into the associated stator slot 3 and fixed in place using at least one positioning contour 6 (see FIG. 3).

It can be seen that the individual positioning contours 6 enable precise positioning and fixing of the individual conductors 4 in the stator slot 3, as well as limiting the gaps 7 through which, for example, a cooling fluid will later flow. The positioning contours 6 are therefore not only used exclusively for positioning and fixing the electrical conductors 4 in the stator slot 3, but can also serve as flow guide elements for guiding the flow of the cooling fluid.

Before inserting the electrical conductors 4 with the insulator 5 surrounding them into the stator slot 3, the latter can be lined with insulating paper 8 (see FIG. 3).

By jointly encasing the electrical conductors 4 with the electrical insulator 5, the embodiment shown in FIG. 2 can be achieved, in which several electrical conductors 4, preferably all electrical conductors 4 belonging in a respective stator slot 3, are not only encased in an electrically insulating manner by the electrical insulator 5 applied in the extrusion process, but are also fixed to one another at the same time. For example, polyamideimide (PAI) or polyetheretherketone (PEEK) can be used as the material for the electrical insulator 5. These plastics are not only easy and inexpensive to process, but also have a high electrical resistance.

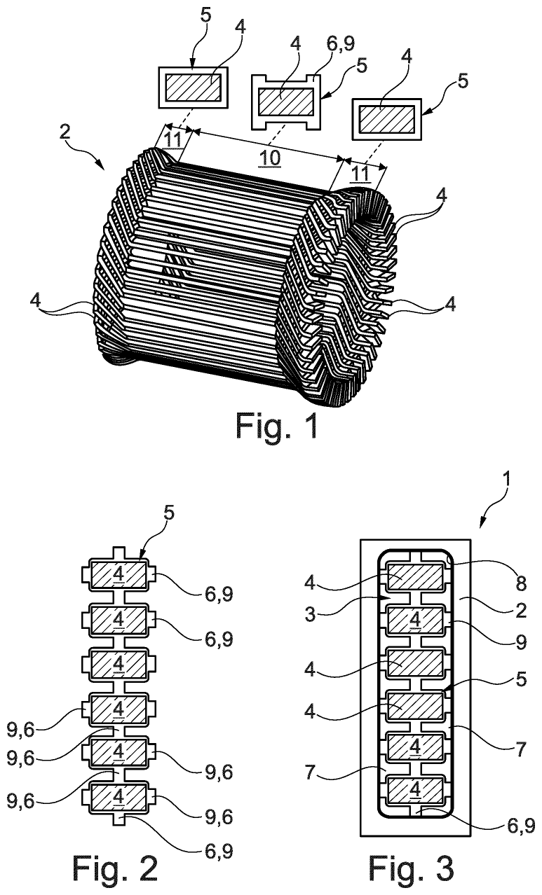

Looking at the electrical conductors 4 according to FIGS. 1 through 3, it can be seen that these have a rectangular cross-sectional shape, for example in the form of so-called hair pins, while the electrical insulator 5 encases each electrical conductor 4 and has a positioning lug 9 as a positioning contour 6 on each side of each conductor 4. The electrical conductors 4 can be connected to each other via two positioning lugs 9 provided between two adjacent electrical conductors 4.

As can be clearly seen in FIG. 3, the positioning lugs 9 enable precise positioning and fixing of the individual electrical conductors 4 in the stator slot 3 as well as limiting the gaps 7 arranged between them, which serve, for example, as fluid channels for a coolant.

Of course, the extruded electrical insulator 5 can also have an H-shaped (see FIG. 1), diamond-shaped or triangular outer contour, which, analogous to the positioning contours 6 or the positioning lugs 9, enables the electrical conductors 4 to be positioned or fixed in the stator slot 3 and the gaps 7 to be limited. The individual positioning contours 6 can also be provided only in a central area 10, while an electrical insulator 5 is provided at the respective longitudinal ends 11 of the electrical conductors 4, but this does not have any such positioning contours 6 or positioning lugs 9.

In purely theoretical terms, it is also conceivable that the electrical conductors 4 are sheathed with the electrical insulator 5 only in the central area 10, but remain free at the longitudinal ends 11, enabling an electrical connection there, for example by welding or soldering, without prior removal of an electrical insulator 5 arranged there

Copper conductors, for example, which are solid or made up of individual strands, can be used as electrical conductors 4.

Overall, with the method according to the invention and the stator 2 or electric motor 1 manufactured according to the method according to the invention, a significant simplification of manufacture can be achieved, because individual positioning of individual electrical conductors or individually sheathed electrical conductors in the respective stator slot 3 is no longer necessary. Rather, the electrical conductors encased in a common electrical insulator can be inserted together into the respective associated stator slot 5 and simply positioned or fixed in the respective stator slot 3 via the corresponding design of the electrical insulator 5, for example with regard to the positioning contours 6 or positioning lugs 9. In particular, this eliminates the need for trickling, in which individual electrical conductors 4 are fixed in the respective stator slots 3 with resin. Costs can also be reduced and defects avoided. At the same time, it is easy to create gaps 7, which serve as subsequent cooling channels.

1. A method for manufacturing an electric motor, comprising:
extruding at least two electrical conductors with an electrical insulator wherein the electrical insulator holds at least two electrical conductors at a distance from one another and has at least one positioning contour, wherein the electric motor has a stator with stator slots and the electrical conductors are sheathed; and
inserting the at least two electrical conductors together with the electrical insulator into an associated stator slot; and
fixing the at least two electrical conductors in the associated stator slot via the at least one positioning contour.

2. The method according to claim 1, further comprising:
coating during the extruding the at least two electrical conductors with a polyamideimide (PAI) or a polyether ether ketone (PEEK).

3. The method according to claim 1, wherein
the at least two electrical conductors have a rectangular cross-sectional shape and the electrical insulator envelops each electrical conductor and has a positioning lug as a positioning contour on each side of each electrical.

4. The method according to claim 3, further comprising:
connecting two adjacent electrical conductors via two positioning lugs arranged between them.

5. The method according to claim 1, further comprising:
enveloping each electrical conductor with the electrical insulator, wherein the at least two electrical conductors have a rectangular cross-sectional shape.

6. The method according to claim 1, wherein
the at least two electrical conductors are sheathed with the electrical insulator in a central region, but remain free at the respective longitudinal ends.

7. The method according to claim 1, wherein the electrical conductors are used as copper conductors.

8. The method according to claim 1, further comprising:
lining the stator slot with an insulating paper before the electrical conductors are inserted with the insulator enclosing them.

9. An electric motor, comprising:
a stator with stator slots and electrical conductors arranged therein, wherein the at least two electrical conductors are sheathed in an extrusion process with an electrical insulator holding the at least two electrical conductors at a distance from one another and having at least one positioning contour, and the at least two electrical conductors together with the electrical insulator are inserted into an associated stator slot and fixed therein via the at least one positioning contour.

10. The electric motor according to claim 9, wherein
the electrical insulator is coated with a polyamideimide (PAI) or polyetheretherketone (PEEK).

11. The electric motor according to claim 9, wherein
the at least two electrical conductors (4) have a rectangular cross-sectional shape and the electrical insulator envelops each electrical conductor and has a positioning lug as a positioning contour on each side of each electrical conductor.

12. The electric motor according to claim 11, wherein
the two adjacent electrical conductors are connected to one another via two positioning lugs arranged between them.

13. The electric motor according to claim 9, wherein
the at least two electrical conductors are sheathed with the electrical insulator in a central region.

14. The electric motor or claim 9, wherein the at least two electrical conductors are coated with a polyamideimide (PAI) or a polyether ether ketone (PEEK).

15. The electric motor according to claim 9, wherein the electrical conductors are used as copper conductors.

16. The method according to claim 5, wherein the electrical insulator has an H-shaped, diamond-shaped, or triangular outer contour.

17. The electric motor according to claim 9, wherein the electrical insulator has an H-shaped, diamond-shaped, or triangular outer contour.

18. An electric motor, comprising:
at least two electrical conductors, wherein the electrical conductors are inserted into a stator slot;
a positioning contour, wherein the electrical conductors are fixed within the stator slot via the positioning contour; and
an electrical insulator, wherein the electrical insulator holds the electrical conductors at a distance from one another.

19. The electric motor according to claim 18, further comprising:
a positioning lug as the positioning contour on each side of each electrical conductors, wherein the at least two electrical conductors have a rectangular cross-sectional shape and the electrical insulator envelops each electrical conductor.

20. The electric motor according to claim 19, wherein the electrical conductors are connected via positioning lugs arranged between them.
